(19) United States
(12) Patent Application Publication
(10) Pub. No.: US 2004/0054522 A1
(43) Pub. Date: Mar. 18, 2004

(54) System and method to access web resources from wireless devices

(76) Inventor: Govindarajan Jagannathan, Herndon, VA (US)

Correspondence Address: Supervisor, Patent Prosecution Services, PIPER RUDNICK LLP, 1200 Nineteenth Street, N.W., Washington, DC, 20036-2412, US

(21) Appl. No.: 10/465,880

(22) Filed: Jun. 20, 2003

Related U.S. Application Data
(60) Provisional application No. 60/389,888, filed on Jun. 20, 2002.

(51) Int. Cl. G06F 17/20

(52) U.S. Cl. 704/8

(57) ABSTRACT

A system and method for using numeric addresses to access a resource on the world wide web (WWW). The method includes: selecting a character string corresponding to the resource; mapping the character string to a numeric string, wherein the numeric string combined with a top level domain extension comprise a numeric string domain address; and providing access to the resource by accepting the character string and the top level domain extension to be entered on a web enabled device, wherein the resource is located by utilizing the numeric string domain address. In one embodiment, a character string that is easy to remember or identified with a particular entity is used.

This application claims priority from U.S. Provisional Application Serial No. 60/389,888 filed Jun. 20, 2002, entitled “Method To Access Web Resources From Wireless Devices.” The entirety of that application is incorporated herein by reference.

### BACKGROUND OF THE INVENTION

1. Field of the Invention

The present invention relates generally to a system and method to access web resources, and relates specifically to a system and method to access web resources from wireless devices.

2. Related Art

U.S. Pat. No. 5,953,392 shows a method and apparatus for telephonically accessing and navigating the Internet. The method includes accessing and browsing the Internet through the use of a telephone and the associated Dual Tone Multiple Frequency (DTMF) signals. The preferred embodiment provides a system that converts the information content of a web page from text to speech (voice signals), signals the hyperlink selections of web page in an audio manner, and allows selection of the hyperlinks through the use of DTMF signals generated from a telephone keypad. Upon receiving a DTMF signal corresponding to a hyperlink, the corresponding web page is fetched and again delivered to the user via one of the available delivery methods such as voice, fax-on-demand, electronic mail, or regular mail.

U.S. Pat. No. 6,243,443 shows a method of making available content resources to users of a telephone network. Contents items are held on Internet servers with each item being locatable at a corresponding Uniform Resource Identifier (URI) having an associated identifying number that can be input using a telephone keypad.

U.S. Pat. No. 6,347,085 shows a method and apparatus for establishing communications between packet-switched and circuit-switched networks. The invention utilizes the existing domain name system infrastructure of the Internet to resolve traditional Public Switched Telephone Networks (PSTN) telephone numbers into domain names, and, using one or more domain name servers, locate the network protocol address of a gateway capable of connecting an executing task on the packet-switched data network to the desired terminating apparatus on the circuit switched communicatio network.

### DESCRIPTION OF THE FIGURES

FIGS. 1, and 2 illustrates prior art use of a typical telephone keypad.

FIG. 3 illustrates an overview of the system, according to an embodiment of the present invention.

FIG. 4 illustrates an overview of the method, according to an embodiment of the present invention.

FIG. 5 illustrates an example of use of a telephone keypad, according to an embodiment of the present invention.

FIG. 6 illustrates details related to the wireless service provider serving the WAP enabled web site after obtaining the IP address from the appropriate domain name server, according to one embodiment of the present invention.

### DESCRIPTION OF THE INVENTION

One embodiment of the present invention uses numeric addresses to access resources on a network. The network may be any network, and includes, but is not limited to: a virtual private network (VPN); a local area network (LAN); a wide area network (WAN); and a world wide web (WWW).

A numeric string domain address is registered with a DNS (Domain Name Service) server that is mapped to an Internet Protocol (IP) address. The numeric string domain addresses are chosen so that they correspond to character strings that are easier to remember (e.g., alphabetical string (names), alpha-numeric strings, symbols, numeric strings).

The present invention is described in the context of the user accessing a network-enabled device (e.g., telephone or other Wireless Application Protocol (WAP) user device) with a specified protocol to reach the resource. The network-enabled device includes any communication device, such as, but not limited to: a Personal Computer (PC), a minicomputer, a microcomputer, a mainframe computer, a hand-held wireless electronic device, a Personal Assistant Device (PAD) or other device with a processor and communication capability. The protocol includes any private or public protocol, such as, but not limited to: a wireless application protocol (WAP), a hypertext transfer protocol (HTTP), a hypertext transfer protocol secure (HTTPS), a file transfer protocol (FTP), and a transmission control protocol/Internet protocol (TCP/IP)

The present invention is also described in the context of using the English alphabet, the arabic numeric system, and the .wap domain name extension. Those skilled in the art, however, will see that any other language can be used, any other numeric system can be used, and that any domain name extension can be used (e.g., .com, .gov, .net, .num.com or .wap.com or .go.com). In addition, the present invention is described in the context of a DNS maintaining the mapping of numbers to an IP address. Those skilled in the art, however, will see that many other entities can perform this function.

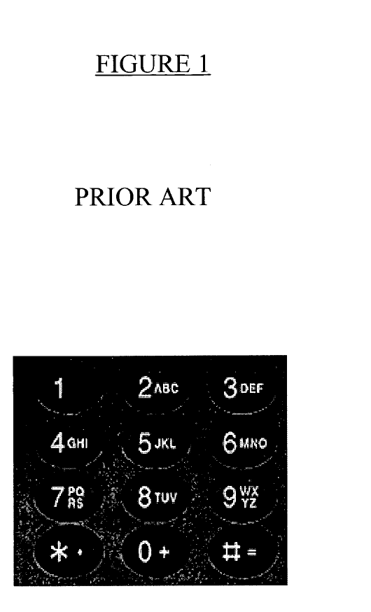

FIG. 1 illustrates a typical telephone keypad. Mobile telephone customers access WAP enabled resources on the world wide web using search engines or by typing in a character based URL or a URI on a telephone keypad, such as the one illustrated in FIG. 1. Those experienced in the art will recognize that other entry mechanisms other than the telephone keypad can be utilized in the present invention (e.g., the keyboard or stylus of a Personal Data Assistant (PDA)). Accessing a WAP enabled resource on the world wide web requires typing in numerous alphabetic characters, which in turn requires numerous keystrokes.

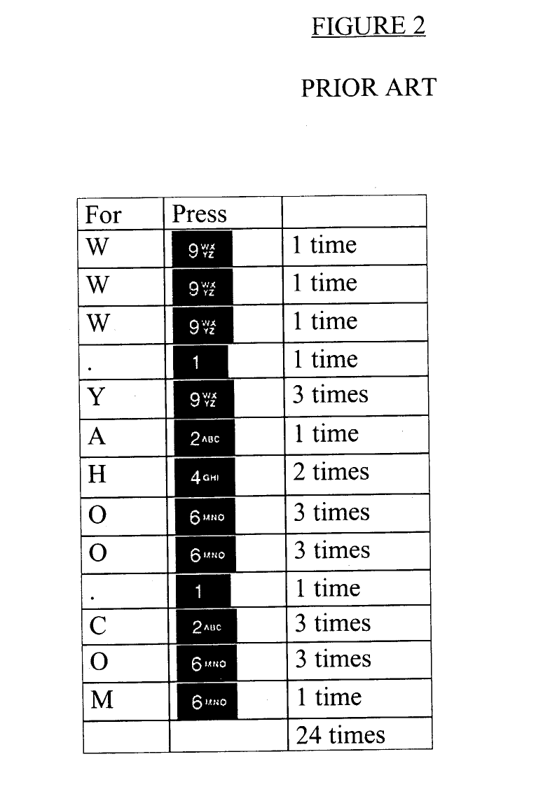

For example, to access www.yahoo.com, the user has to press the keys in the sequence illustrated in FIG. 2. Thus, for example, to enter a W, the user must press the 9 key one time. As another example, to access a Y, the user must press the 9 key three times. As illustrated in FIG. 2, to access www.yahoo.com requires multiple keystrokes. It is tedious to correct mistakes when trying to type characters using the telephone keypad.

Overview System and Method

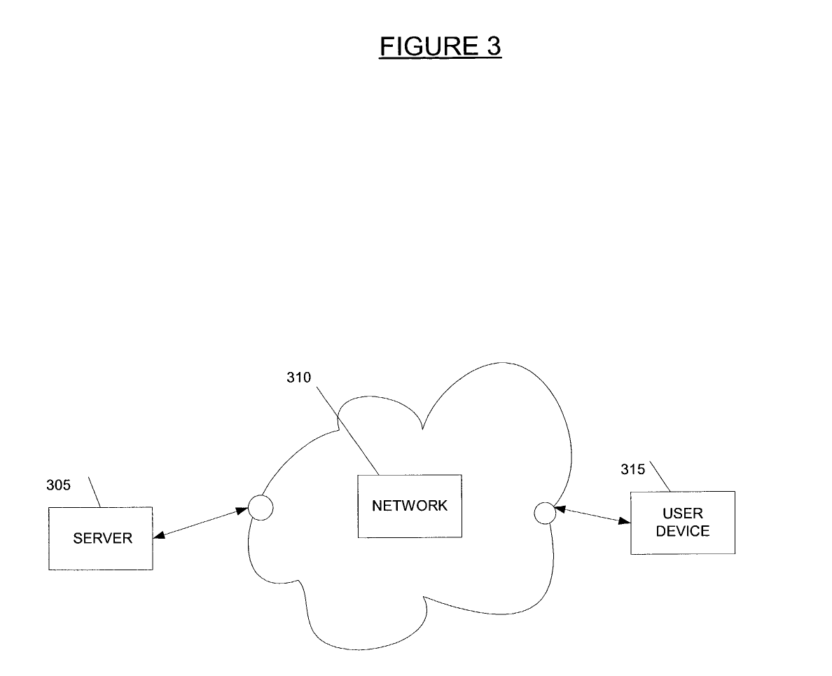

FIG. 3 illustrates an overview diagram of the system, according to one embodiment of the present invention. The server 305 is a computer running administrative software on a network that controls access to the network and its resources, and provides resources to computers functioning as workstations on the network. The network 310 is a group of computers and associated devices that are connected by communications facilities. The user telephone or other device 315 is a device used to access and communicate with the network and server.

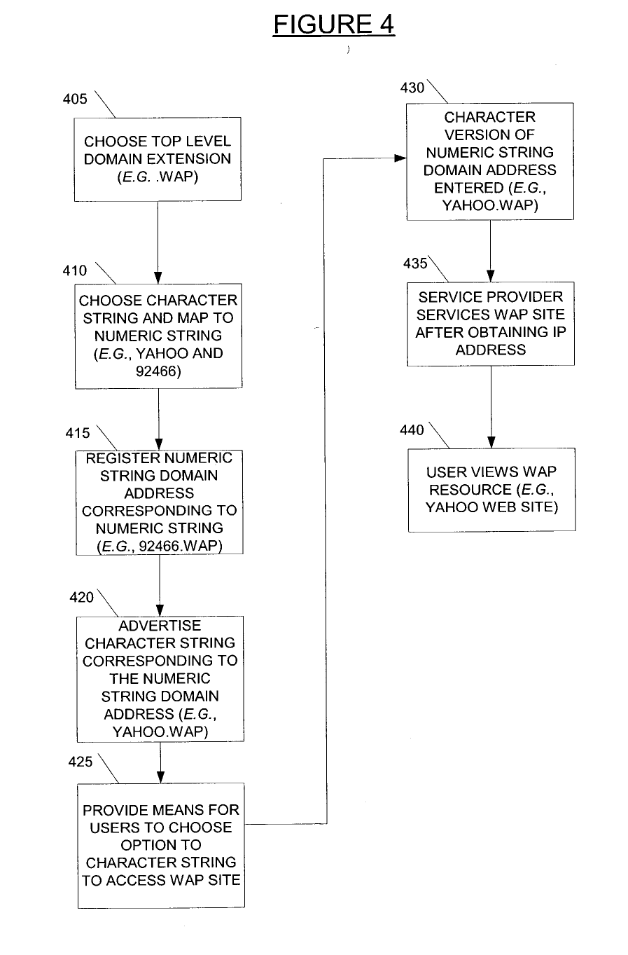

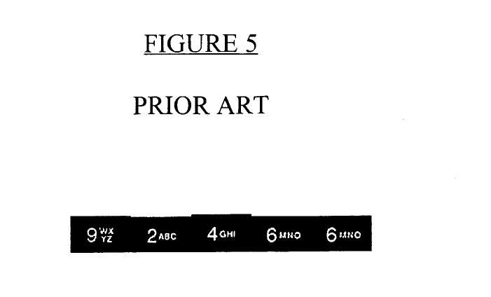

FIG. 4 illustrates an overview flowchart of the method, according to one embodiment of the present invention. The example of accessing www.yahoo.com is used to illustrate this overview method. In step 405, a top level domain extension is chosen to implement the solution. For example, the extension .wap is chosen. In step 410, a character string is chosen and mapped to a numeric string. In one embodiment, the character string is an easy-to-remember name or string that is identified with a particular entity (e.g., Yahoo). The character string can be any character string, including an alphabetic string (e.g., Yahoo), an alpha-numeric string (e.g., 4sale); a numeric string (e.g., 911), a symbolic string (e.g., $$$); an alpha-symbolic string (e.g., free$), or a numeric-symbolic string (e.g., 7-11). For example, for a Yahoo web site, the numeric string 92466 is chosen to map to the alphabetical name Yahoo, as it is entered on a telephone keypad, as illustrated in FIG. 5.

In step 415, the numeric string is registered as a domain address and the domain registration service adds the IP address and the numeric domain registration number to the domain name service's servers. For example, www.92466.wap is registered with an appropriate domain name registration service. The web site www.92466.wap then corresponds to an IP address such as 127.0.0.1.

In step 420, the character string is optionally advertised to users for accessing the web site. Thus, yahoo.wap is advertised to users as a web site to access a Yahoo web site from a telephone, PDA, or other WAP enabled device.

In step 425, means are provided for users to enter in the character string in a manner that accesses the WAP enabled resource corresponding to that character string. For example, telephone and PDA manufacturers or wireless service providers can provide means for users to enter in a character string (e.g., Yahoo) followed by .wap, or alternatively, enter in the numeric string 92466, followed by entering in a WAP option. As another alternative, for example, telephones and PDAs may have a hot button marked “WAP” that provides the user with an option to enter the numeric string domain address 92466. In another example, wireless service providers may provide a menu option for WAP, which when chosen allows the user to enter a character string corresponding to a numeric string domain address. As an additional example, users who want to access WAP enabled web sites may use a hot button in the telephone and PDA or use the WAP option in the wireless service provider menu to enter the numeric string domain address.

In step 430, the character string (which is mapped to the numeric string) is entered. For example, a user presses the letters Y-A-H-0-0, which correspond to the numbers 9-2-4-6-6. (On a telephone pad, 9 contains a Y, 2 contains an A, 4 contains an H, 6 contains an 0, and 6 contains an 0. Thus 92466=Yahoo.) As explained in 425, when this character string Y-A-H-O-O is followed by a WAP entry, this allows the users to access the numeric string domain address 92466.wap.

In step 435, a wireless service provider serves the WAP enabled web site after obtaining the IP address from the appropriate domain name server. For example, a wireless service provider serves the 92466.wap web site after obtaining the corresponding IP address 127.0.0.1.

In step 440, the WAP enabled resource is accessed. Thus, in the example, the Web site of Yahoo corresponding to the 92466.wap domain address is accessed.

The present invention allows users to be able to access web sites with substantially less key strokes. For example, as illustrated in FIG. 5, accessing Yahoo requires 5 key strokes instead of 24 key strokes. In addition, the names corresponding to the numeric string domain addresses can be remembered more easily than the numeric strings. For example, it is easier to remember Yahoo than 92466.

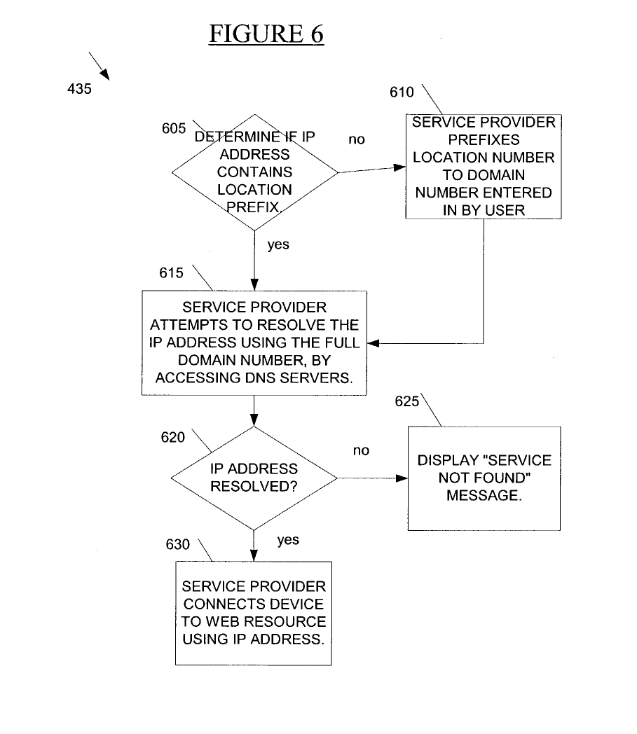

FIG. 6 illustrates substeps of step 435, when the wireless service provider serves the WAP enabled web site after obtaining the IP address from the appropriate domain name server, according to one embodiment of the present invention. In step 605, it is determined whether the ID number contains a location prefix. If no, in step 610, the wireless service provider prefixes the location number to the domain number keyed in by the user. The process then moves to step 615. If the answer to step 605 is yes, the process skips to step 615, where the wireless service provider attempts to resolve the IP address by using the full domain number, by accessing the DNS servers. In step 620, it is determined if the IP address is resolved. If no, in step 625, the message “service not found” is displayed. If yes, in step 630, the wireless service provider connects the device to the web resource the user is trying to access using the IP address.

### Additional Embodiments

In an embodiment of the present invention, to increase the number of addresses that may be stored, in addition to the embodiment described above, the numeric addresses may be localized using telephone area codes. For example, the movie ticket reservation site for AMC Theaters in Northern Virginia could be 703.262 where 703 is the telephone area code of northern Virginia and 262 are the numbers on the telephone keypad that contain the alphabet letters AMC.

In another embodiment of the present invention, the numeric addresses are global and the prefixed numbers are localized addresses.

For example AMCUS (these letters on the telephone keypad correspond to the numeric string domain address 26287.wap) could be AMC's global web site while 703.262 (corresponding to 703AMC on the telephone keypad) could be AMC's northern Virginia web site, and 212.262 (corresponding to 212AMC on the telephone keypad) could be AMC's New York metro area web site.

In an additional embodiment of the present invention, the wireless service provider could automatically fill the local area code because the local area code is easily available based on the location information available with the service provider. The user could choose either the local or global option either using a menu option in the telephone or using a hot button. For example, if the wireless device is connected through a tower in Arlington, Va. the wireless service provider could automatically attach the 703 prefix to the address if the user chooses this option.

In a further embodiment of the present invention, standard words (e.g., names, addresses, user identifiers (IDs), passwords), may be registered by the user and stored in the telephone itself or by the service provider. For example, if the user wants to store a name that is frequently used, the name may be stored in the device itself or by the service provider using the provider's resources. Thus, for example, John Doe may be saved as 5646363 in the telephone and may be retrieved anytime by typing this number in combination with a hot key on the device or by choosing a menu option on the device.

In an additional embodiment of the present invention, numbers such as telephone numbers may also be used as addresses. For example, if the number for AMC Movies is 703-542-9999, the numeric string domain address 7035429999.wap may be used. This is particularly helpful where certain telephone numbers are found in directories. As another example, a store telephone number could be used to map to the web site of the specific store and also the department telephone numbers could be used to point to the department web pages. For example, the telephone number for the Dulles Town Center Sears could be used to map to the domain address of the Dulles Town Center Sears store and the Home Appliances telephone number in the store may be used to map to the Sears Home Appliances web page.

In another embodiment of the present invention, any top level domain extension, including those existing now (e.g., .com and .net) and those not yet in existence, may be chosen to implement the present invention. In addition, country specific top level domain extensions may be used (e.g., uk.nu and fr.wp).

In an additional embodiment of the present invention, the entering of a numeric string domain address is initiated by use of a hot key, menu option, or other means.

In another embodiment, when more than one character string maps to a particular numeric string, a user is presented with the options and is able to make a choice. Thus, for example, ABC and AAA both map to the numeric string 222. In this embodiment, if the user entered in 222, he would be given the option of choosing ABC or AAA.

In an additional embodiment, the user is able to distinguish between alphabetic choices on a keypad so that more than one option is not possible for a particular numeric string. Thus, for example, on a keypad, the number 2 represents A, B, and C. To distinguish between these three choices, the user could: press 2 once to signify A, press 2 twice to signify B, and press 2 three times to signify C. Those experience in the art will see that other method of distinguishing between A, B, and C could also be used.

In a further embodiment of the present invention, use is extended to land-line telephones that are web-enabled.

In another embodiment of the present invention, use is extended to access .html pages from a computer connected to the Internet.

In a further embodiment of the present invention, use is extended to access any web resource from any device that is connected to the Internet.

Another embodiment of the present invention includes the use of a logo or a symbol in a directory to denote that the telephone number may be used to access a WAP enabled web site. The symbol may be WAP, WWW, or any other symbol and the symbol printed next to the telephone number in the directory would mean that the telephone number may be used to access the web site of the entity that corresponds to the telephone number.

Additional embodiments of the present invention include: a directory for numeric string domain addresses, similar to telephone number directories; yellow pages for numeric string domain addresses; and directory assistance service for numeric string domain addresses.

Additional advantages and novel features of the invention will become apparent to those skilled in the art upon examination of the application or upon learning by practice of the invention.

What is claimed is:

1. A method of accessing a resource on a network, comprising:
selecting a character string corresponding to the resource;
mapping the character string to a numeric string, wherein the numeric string combined with a top level domain extension comprise a numeric string domain address; and
providing access to the resource by accepting the character string and the top level domain extension to be entered on an accessing device, wherein the resource is located by utilizing the numeric string domain address.

2. The network is at least one of:
a virtual private network (VPN);
a local area network (LAN);
a wide area network (WAN); and
a world wide web (WWW).

3. The method of claim 1, wherein the character string is at least one of:
an alphabetic string;
an alpha-numeric string;
a numeric string;
a symbolic string;
an alpha-symbolic string;
an numeric-symbolic string;
a character string that is easy-to-remember; and
a character string associated with an entity.

4. The method of claim 1, wherein the character string utilizes the English language.

5. The method of claim 1, wherein the character string utilizes any language.

6. The method of claim 1, wherein the numeric string utilizes an arabic numeric system.

7. The method of claim 1, wherein the numeric string utilizes any numeric system.

8. The method of claim 1, wherein the numeric string comprises:
a telephone area code; and
a numeric string corresponding to a character string.

9. The method of claim 1, wherein the character string is at least one of:
a local option;
a national option; and
a global option.

10. The method of claim 1, wherein the character string corresponds to a telephone number.

11. The method of claim 1, wherein the top level domain extension is country specific.

12. The method of claim 1, wherein the accessing device is at least one of:
a device accessible for a specified protocol;
a mobile telephone
a personal device assistant (PDA);
a land-line telephone;
a computer; and
a device connected to the network.

13. The method of claim 12, wherein the specified protocol is at least one of:
a wireless application protocol (WAP);
a hypertext transfer protocol (HTTP);
a hypertext transfer protocol secure (HTTPS);
a file transfer protocol (FTP); and
a transmission control protocol/Internet protocol (TCP/IP).

14. The method of claim 1, wherein a designated symbol is placed next to a telephone number to indicate that the telephone number may be used as the numeric string in the numeric string domain address.

15. The method of claim 1, wherein the numeric string domain address is a registered numeric string domain address.

16. The method of claim 1, further comprising:
advertising the character string.

17. The method of claim 1, further comprising:
presenting a user with possible options when more than one character string is mapped to the same numeric string.

18. The method of claim 1, wherein a unique character string is mapped to a unique numeric string.

19. A computer program product comprising a computer usable medium having control logic stored therein for causing a computer to access a resource on a network, the control logic comprising:
first computer readable program means for storing a selected character string corresponding to the resource;
second computer readable program means for mapping the character string to a numeric string, wherein the numeric string combined with a top level domain extension comprise a numeric string domain address; and
third computer readable program means for providing access to the resource by accepting the character string and the top level domain extension to be entered on a network-enabled device, wherein the resource is located by utilizing the numeric string domain address.

20. A computerized system for accessing a resource on a network, comprising:
at least one network-enabled device coupled to the network; and
at least one server coupled to the network;
wherein the at least one server comprises a program that enables:
storing a selected character string corresponding to the resource;
mapping the character string to a numeric string, wherein the numeric string combined with a top level domain extension comprise a numeric string domain address; and
providing access to the resource by accepting the character string and the top level domain extension to be entered on the network-enabled device, wherein the resource is located by utilizing the numeric string domain address.
